(19) United States
(12) Patent Application Publication
(10) Pub. No.: US 2016/0283233 A1
(43) Pub. Date: Sep. 29, 2016

(54) COMPUTER SYSTEMS AND METHODS FOR CONTEXT SWITCHING

(71) Applicant: FREESCALE SEMICONDUCTOR, INC., Austin, TX (US)

(72) Inventors: PETER J. WILSON, LEANDER, TX (US); BRIAN C. KAHNE, AUSTIN, TX (US)

(21) Appl. No.: 14/667,229

(22) Filed: Mar. 24, 2015

(51) Int. Cl. G06F 9/30; G06F 9/38

(52) U.S. Cl. CPC G06F 9/30072; G06F 9/30145; G06F 9/3867

(57) ABSTRACT

A data processing system includes a plurality of contexts, a current context indicator configured to indicate a context of the plurality of contexts as the current context, an instruction queue configured to store fetched instructions for execution using in the current context, and a scheduler coupled to the context selector. The scheduler is configured to, in response to a context switch event, save a current context instruction state from the instruction queue to the corresponding instruction buffer of the current context, select a next context of the plurality of contexts, restore a context instruction state from the corresponding instruction buffer of the next context to the instruction queue, and set the current context indicator to indicate the selected next context as the current context.

### BACKGROUND

1. Field

This disclosure relates generally to computer processor architecture, and more specifically, to context switching in multi-threaded computer processors.

2. Related Art

In a processing core with multiple contexts and the ability to switch between them as they become stalled or ready, it can take time to start fetching instructions when one context is de-scheduled and another started. In order to speed up processing, it is desirable to reduce the time required to switch contexts.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 illustrates, in block diagram form, a portion of a pipelineable data processing system in accordance with an embodiment of the present invention.

FIG. 2 illustrates in block diagram form an exemplary processor of the data processing system of FIG. 1 in accordance with one embodiment of the present invention.

FIG. 3 illustrates in block diagram form further detail of the contexts and context management unit of FIG. 2 in accordance with one embodiment of the present invention.

FIG. 4 illustrates, in flow diagram form, a method of switching contexts in a computer processor in accordance with an embodiment of the present invention.

### DETAILED DESCRIPTION

Embodiments of systems and methods disclosed herein use the data and instructions in the instruction queue already in process during the execution of a context to accelerate restarting the context. An instruction buffer is associated with each context. Upon de-scheduling a context because of a stall, the current instruction buffer is written into the context's private instruction buffer. When a decision to execute that context again is made, the instruction buffer contents are used as the instruction stream. If the instruction buffer is nearly empty at the time, a further cacheline for the context can be read and stored.

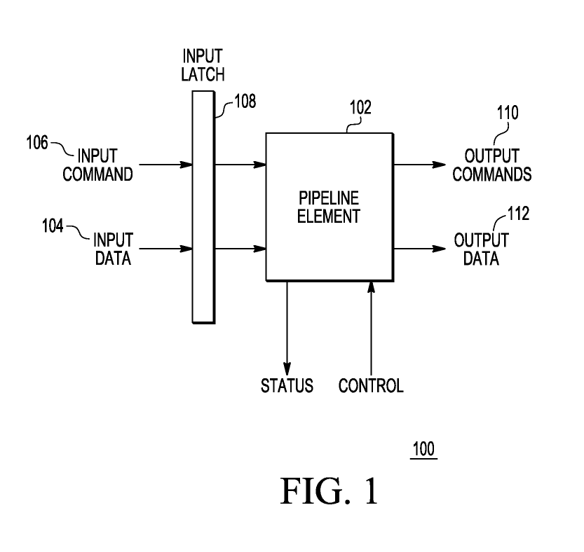

FIG. 1 illustrates, in block diagram form, a portion of a pipelineable data processing system 100 in accordance with an embodiment of the present invention including processing unit or pipelined element 102 which is responsive to input data 104 and input commands 106 received through input latch 108. Pipelined element 102 generates output commands 110 and output data 112 which are used to interface with other circuits. The detailed behavior of pipelined element 102 may be controlled via information sent on one or more control lines and may provide status via one or more status lines.

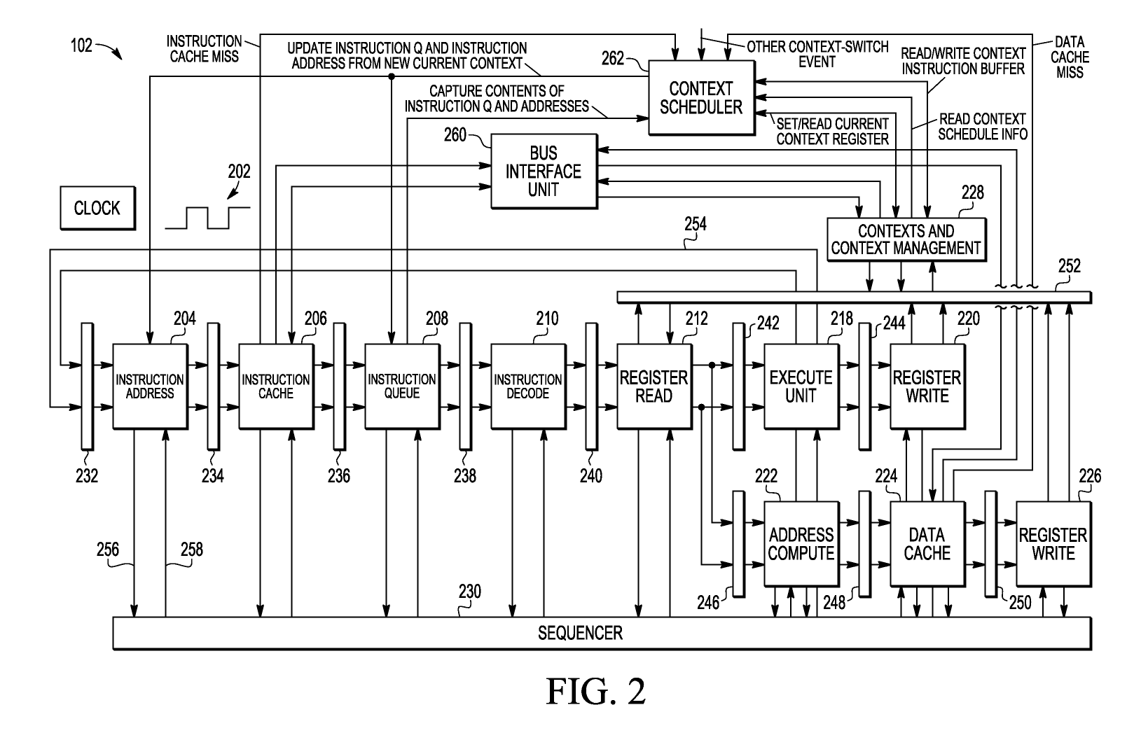

FIG. 2 illustrates in block diagram form further detail of an embodiment of pipelined element of FIG. 1. For the purposes of example, a canonical pipelined microprocessor is described herein, however the claims are not intended to be limited to a particular processing system architecture and one of ordinary skill in the art will appreciate that other microprocessor configurations can be used as well. A canonical pipelined microprocessor includes a number of different pipelined elements 102, each generally of the form depicted in FIG. 1. In operation, each pipelined element 102 reads data and performs various appropriate internal operations in response to a clock signal 202. Other configurations that are self-timed are also possible.

A pipelined processing system constructed from one or more pipelined elements 102 generally includes instruction address block 204, an instruction cache 206, an instruction queue block 208, an instruction decode block 210, a register read block 212, an execute unit 218, a register write block 220, an address compute unit 222, a data cache 224, a second register write block 226, contexts and context management unit 228, and a sequencer 230, as well as a plurality of input latches 232-252 associated with each functional block. Also included is a branch path 254 and control and status signals for each pipelined element 102. For simplicity only one pair of status and control signals are represented by designators 256, 258. Pipelined elements 102 can also include Bus Interface Unit (BIU) 260 and context scheduler 262. Again, other configurations for pipelined elements it 102 can be used.

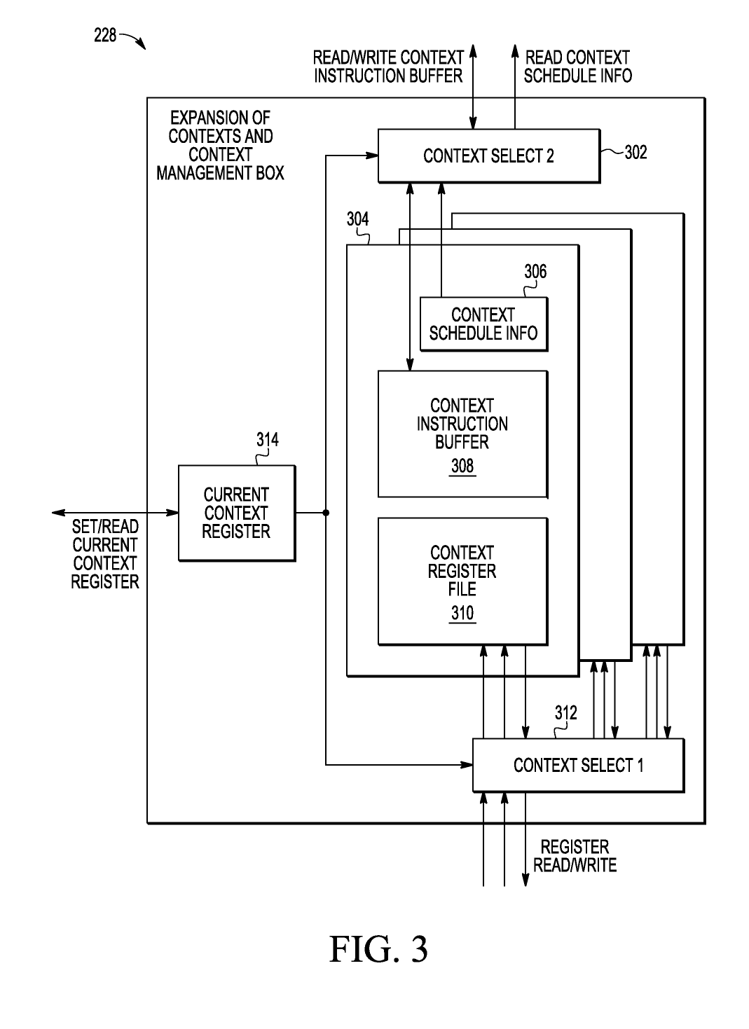

Referring to FIGS. 2 and 3, FIG. 3 illustrates in block diagram form further detail of the contexts and context management unit 228 of FIG. 2 that includes first and second context select interfaces 302, 312, one or more context blocks 304 that each include context schedule information 306, context instruction buffer 308, and context register file 310, and current context register 314. Context scheduler 262 is coupled to provide information to update instruction queues and addresses associated with a new context to instruction address block 204 and instruction queue 208. Information that may cause a context switch is provided to context scheduler 262 from various sources, such as, for example, instruction cache misses from instruction cache 206 and data cache misses from data cache 224. Other information that can cause a context switch can be provided to context scheduler 262 from other appropriate sources.

Contexts and context management unit 228 communicates with context scheduler 262 to set/read a current context register file 310, read context schedule information 306 from context scheduler 262, and to read or write a context instruction buffer 308. Contexts and context management unit 228 also communicates with latch 252 to read/write register file 310 for one or more contexts 304. Context select interface 302 provides or retrieves information from context schedule information 306 and context instruction buffer 308 of a selected context 304. Context select interface 312 provides or retrieves information from the register file 310 of a selected context 304. Current context register 314 can be used to indicate the current context, and can be accessed to set or read the context being executed, and to provide current the context to context select interfaces 302, 312.

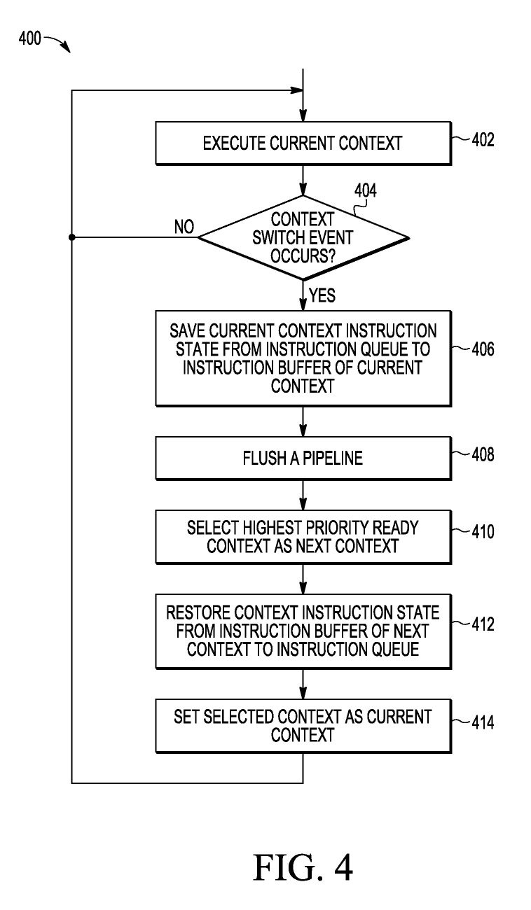

Referring to FIGS. 2, 3 and 4, FIG. 4 illustrates, in flow diagram form, a method 400 of switching contexts in pipelined element 102 in accordance with an embodiment of the present invention. Process 402 includes executing a current context in pipelined element 102 until a context switch event is detected in process 404. Once the context switch event occurs, process 406 includes saving the current context instruction state from instruction queue 208 to context instruction buffer 308 of the current context 304. Process 408 includes flushing the instruction pipeline of pipelined element 102 of data associated with the current context. Components that may be flushed include instruction address block 204, instruction cache 206, instruction queue block 208, instruction decode block 210, register read block 212, execute unit 218, register write block 220, and address compute unit 222.

Once the current context instruction state is saved, process 410 includes selecting a context as a next context. Information to allow the selection can be provided in context schedule information 306. Example selection mechanisms include selecting any ready context and selecting the highest priority ready context. Selecting any ready context requires the storing of state indicating readiness in the context schedule information. The state is changed from not ready to ready when the situation causing the context switch event is resolved. For example, if the context switch event were a message unavailable event, the context would be marked ready when a message was delivered to the context. A message unavailable event occurs when the executing context attempts to read a message but no message is available. Selecting the highest priority ready context requires keeping context priority information in the context schedule information along with the indicator of readiness. Process 412 then restores the context instruction state from the instruction buffer 308 of the next context to instruction queue 208. Process 414 sets the selected or next context 304 as the current context and sets an indicator of the current context in current context register 314.

Each context 304 thus has a context instruction buffer 308. When the current context is descheduled, the contents of the instruction queue 208 are stored into context instruction buffer 308 for the respective context 304. When the context is re-scheduled, instruction queue 208 is filled from the corresponding context instruction buffer 308, reducing context switch overhead. Context switch overhead may be further reduced by performing two or more of the processes of method 400 in parallel. For example, a context switch event can occur in process 404 while the current context is being executed in process 402. As another example, the pipeline can be flushed in process 408 while process 406 saves the context instruction state and process 410 selects the highest priority ready context as the next context. As a further example, process 412 can restore the context instruction state from the instruction buffer of the next context to the instruction queue, while process 414 sets the selected or next context as the current context.

Instruction block 204 stores a value representing the address of the next instruction to be executed. This value is presented to input latch 234 of the instruction cache 206 at every clock signal, prior to the rising edge of the clock. The instruction cache 206 then uses this address to read the corresponding instruction from within itself. The instruction cache 206 then presents the address and instruction to the instruction queue block 208 before the next rising clock edge via latch 236. On the rising clock edge, the instruction queue block 208 adds the address and the instruction to the end of its internal queue and removes the instruction and address at the bottom of its queue before the next rising edge of the clock, providing both the instruction and address through latch 238 to the instruction decode block 210. The instruction decode block 210 reads the instruction and address from its input latch 238 at the rising edge of the clock. The instruction decode block 210 examines the instruction and generates output data containing (depending on the instruction) specifications of the registers to be used in the execution of the instruction, any data value from the instruction, and a recoding of the operation requested by the instruction.

The register read block 212 reads the incoming data from the instruction decode block 210 at the rising edge of the clock and causes, through latch 252, reads the values of the current context register 304 in the first half of the clock period. The information from the current context register 304 and the decode block 210 is provided to the address compute unit 222 and the execute unit 218 before the clock's next rising edge. Both the address compute unit 222 and the execute unit 218 read the data from their input latches 246, 242 respectively, before the rising edge of the clock. One portion of the data specifies the operation required, and either the execute unit 218 or the address compute unit 222 will obey. The execute unit 218 that does not obey produces no output.

If the execute unit 218 is required to act, execute unit 218 will perform the appropriate computation on the values provided and will produce an output before the rising edge of the next clock. This output is read at the rising edge by the register write block 220 which receives a destination register specifier and a value to be written thereto.

If the operation requested requires the address compute unit 222 to act, the execute unit 218 performs no function, and the address compute unit performs appropriate arithmetic functions, such as adding two values, and provides the result to the data cache 224 along with the requested operation before the next rising edge of the clock. The data cache 224 reads this information from input latch 248 at the rising edge of the clock, and performs appropriate action on its internal memory, within the clock timeframe. If the operation requested is a load operation, the value read from the data memory 224 is presented to the second write register 226, before the rising edge of the clock. On the rising edge of the clock, the second write register 226 captures the register specifier and value to be written, and forces the current context register 314 to write to that specified register. The sequencer 230 has knowledge of how much time the various execution units require to complete the tasks they have been given and can arrange for one or more pipelined elements 102 in the microprocessor pipeline to freeze (for example when a multi-cycle instruction writes a register used as a source in the next instruction).

The sequencer 230 communicates with components of pipelined element 102 by reading the status signal 256 and providing the control signal 258. Some instructions, such as multiplication instructions often take multiple cycles.

In addition to the above description, the pipelined element 102 can utilize branch instructions, which may cause the microprocessor to execute an instruction other than the next sequential instruction. Branches are further handled by branch path 254 from the execute unit 218 to the instruction address block 204. When a branch must be taken, the execute unit 218 provides the desired address and signals to the sequencer 230. The instruction address block 204 changes its stored internal value to the new address and provides it to the instruction memory 206. The sequencer 230 tracks the progress of the new instruction down the pipeline, ensuring that no registers are changed by instructions in the pipeline between the branch instruction and the new instruction.

The instruction cache 206 and data cache 224 may also be implemented as simple memories or as a hierarchy of caches if desired. Memory management units (MMUs) (not shown) may also be provided to operate in parallel with the caches 206, 224 and provide address translation and protection mechanisms.

When the instruction cache 206 or data cache 224 do not contain the data requested then the sequencer 230 may cause them to signal the Bus Interface Unit (BIU) 260 through the appropriate cache. The BIU 260 intercedes between the pipelined element 102 and the rest of the system 100 (FIG. 1), marshaling requests (such as a request to read a memory location or to write a memory location) to the rest of the system 100 and capturing and properly directing responses from the system to pipelined element 102.

Rather than using the sequencer 230 to have specific knowledge of how long an operation might take, the context register files 310 can be provided with a busy bit. A busy bit can be set to a first value such as 1 if a register file 310 is not available for use, and can be set to a second value such as 0 if the register file 310 is ready for use. When a multiple-cycle operation such as a multiply or a read from the data cache 224 occurs, the destination register of a context register file 310 can have its busy bit set by the sequencer 230. Before allowing a register file 310 to be read, the Register Read stage 212 can check that all the register files 310 to be used by an instruction have empty busy bits. If a register file 310 has a set busy bit, the sequencer 230 stalls that instruction at the register read stage, awaiting completion of a prior operation targeting the register file(s) 310 with busy bits. When all register files 310 involved have zero busy bits, the instruction is allowed to continue, setting an appropriate busy bit if it is a multicycle operation.

By now it should be apparent that in some embodiments, a data processing system can comprise a plurality of contexts (304). Each context includes a corresponding register file (310) and a corresponding instruction buffer (308). A current context indicator (314) can be configured to indicate a context of the plurality of contexts as the current context. An instruction queue (208) can be configured to store fetched instructions for execution using the current context. A scheduler (262) coupled to the context selector and configured to, in response to a context switch event, save a current context instruction state from the instruction queue to the corresponding instruction buffer of the current context, select a next context of the plurality of contexts, restore a context instruction state from the corresponding instruction buffer of the next context to the instruction queue, and set the current context indicator to indicate the selected next context as the current context.

In another aspect, the current context instruction state can comprise the fetched instructions of the current context.

In another aspect, the data processing system can further comprise an instruction pipeline (208, 210, 312, 218, 220), wherein the instruction pipeline comprises the instruction queue, and a sequencer (230) coupled to the instruction pipeline and configured to, in response to the context switch event, flush the pipeline.

In another aspect, the instruction pipeline can be configured to, after the selected next context is set as the current context in response to the context switch event, continue instruction execution with the restored fetched instructions in the instruction queue.

In another aspect, the instruction pipeline can comprise an instruction decode unit (210) and can be configured to continue execution with the restored fetched instructions by providing a next instruction of the restored fetched instructions to the instruction decode unit.

In another aspect, the context switch event can comprise a cache miss.

In another aspect, the context switch event can comprise a response to an interrupt.

In another aspect, each context of the plurality of contexts can further comprise context scheduling information (306).

In another aspect, the context scheduling information in each context of the plurality of contexts can include a ready indicator. The scheduler can be configured to, in response to the context switch event, use the context scheduling information in each of the plurality of contexts to select a ready context as the next context.

In another embodiment, a data processing system can comprise an instruction pipeline having an instruction queue (208) configured to store fetched instructions, an instruction decode unit (210) coupled to receive fetched instructions from the instruction queue, and an execution unit (218) coupled to receive decoded instructions from the instruction decode unit. A plurality of contexts (304) can be coupled to the instruction pipeline. Each context can include a corresponding register file (310) and a corresponding instruction buffer (308). A current context indicator (314) can be configured to indicate a context of the plurality of contexts as the current context. A scheduler (262) can be coupled to the context selector and configured to, in response to a context switch event, save the fetched instructions from the instruction queue to the corresponding instruction buffer of the current context, select a next context of the plurality of contexts, restore fetched instructions from the corresponding instruction buffer of the next context to the instruction queue, and set the current context indicator to indicate the selected next context as the current context.

In another aspect, the context switch event can comprise a cache miss.

In another aspect, the context switch event can comprise a response to an interrupt.

In another aspect, the context switch event can comprise a message unavailable event.

In another aspect, each context of the plurality of contexts can further comprise context scheduling information. The scheduler can be configured to, in response to the context switch event, use the context scheduling information in each of the plurality of contexts to select a next ready context as the next context.

In another embodiment, in a data processing system having an instruction pipeline and a plurality of contexts, each context having a corresponding register file and a corresponding instruction buffer, a method can comprise executing (102) a current context by the instruction pipeline, determining (104) occurrence of a context switch event, and in response to the context switch event, the method can further comprise saving (108) a current context instruction state from the instruction pipeline to the corresponding instruction buffer of the current context, selecting (110) a next context of the plurality of contexts, and restoring (112) a context instruction state to the instruction pipeline from the corresponding instruction buffer of the next context.

In another aspect, the executing in the current context can comprise storing fetched instructions into an instruction queue (208) of the instruction pipeline. The saving the current context instruction state can comprise storing the fetched instruction from the instruction queue to the corresponding instruction buffer of the current context.

In another aspect, the restoring the context instruction state can comprise restoring fetched instructions from the corresponding instruction buffer of the next context to the instruction queue.

In another aspect, after the restoring the context instruction state to the pipeline, the method can further comprise setting (114) the selected next context as the current context, and executing the restored fetched instructions by the instruction pipeline.

In another aspect, the context switch event can be determined in response to one of a cache miss, a response to an interrupt, or a message unavailable event.

In another aspect, in response to the context switch event, the method can further comprise flushing the pipeline.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the disclosure. Of course, the description of the architecture has been simplified for purposes of discussion, and it is just one of many different types of appropriate architectures that may be used in accordance with the disclosure. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A data processing system comprising:
a plurality of contexts, wherein each context includes a corresponding register file and a corresponding instruction buffer;
a current context indicator configured to indicate a context of the plurality of contexts as the current context;
an instruction queue configured to store fetched instructions for execution using the current context;
a scheduler coupled to the context selector and configured to, in response to a context switch event, save a current context instruction state from the instruction queue to the corresponding instruction buffer of the current context, select a next context of the plurality of contexts, restore a context instruction state from the corresponding instruction buffer of the next context to the instruction queue, and set the current context indicator to indicate the selected next context as the current context.

2. The data processing system of claim 1, wherein the current context instruction state comprises the fetched instructions of the current context.

3. The data processing system of claim 1, further comprising an instruction pipeline, wherein the instruction pipeline comprises the instruction queue, and a sequencer coupled to the instruction pipeline and configured to, in response to the context switch event, flush the pipeline.

4. The data processing system of claim 3, wherein the instruction pipeline is configured to, after the selected next context is set as the current context in response to the context switch event, continue instruction execution with the restored fetched instructions in the instruction queue.

5. The data processing system of claim 4, wherein the instruction pipeline comprises an instruction decode unit and is configured to continue execution with the restored fetched instructions by providing a next instruction of the restored fetched instructions to the instruction decode unit.

6. The data processing system of claim 1, wherein the context switch event comprises a cache miss.

7. The data processing system of claim 1, wherein the context switch event comprises a response to an interrupt.

8. The data processing system of claim 1, wherein each context of the plurality of contexts further comprises context scheduling information.

9. The data processing system of claim 8, wherein the context scheduling information in each context of the plurality of contexts includes a ready indicator, wherein the scheduler is configured to, in response to the context switch event, use the context scheduling information in each of the plurality of contexts to select a ready context as the next context.

10. A data processing system comprising:
an instruction pipeline having an instruction queue configured to store fetched instructions, an instruction decode unit coupled to receive fetched instructions from the instruction queue, and an execution unit coupled to receive decoded instructions from the instruction decode unit;
a plurality of contexts coupled to the instruction pipeline, wherein each context includes a corresponding register file and a corresponding instruction buffer;
a current context indicator configured to indicate a context of the plurality of contexts as the current context;
a scheduler coupled to the context selector and configured to, in response to a context switch event, save the fetched instructions from the instruction queue to the corresponding instruction buffer of the current context, select a next context of the plurality of contexts, restore fetched instructions from the corresponding instruction buffer of the next context to the instruction queue, and set the current context indicator to indicate the selected next context as the current context.

11. The data processing system of claim 10, wherein the context switch event comprises a cache miss.

12. The data processing system of claim 10, wherein the context switch event comprises a response to an interrupt.

13. The data processing system of claim 10, wherein the context switch event comprises a message unavailable event.

14. The data processing system of claim 13, wherein each context of the plurality of contexts further comprises context scheduling information, and wherein the scheduler is configured to, in response to the context switch event, use the context scheduling information in each of the plurality of contexts to select a next ready context as the next context.

15. In a data processing system having an instruction pipeline and a plurality of contexts, each context having a corresponding register file and a corresponding instruction buffer, a method comprising:
executing a current context by the instruction pipeline;
determining occurrence of a context switch event; and
in response to the context switch event, the method further comprises:
saving a current context instruction state from the instruction pipeline to the corresponding instruction buffer of the current context;
selecting a next context of the plurality of contexts; and
restoring a context instruction state to the instruction pipeline from the corresponding instruction buffer of the next context.

16. The method of claim 15, wherein the executing in the current context comprises storing fetched instructions into an instruction queue of the instruction pipeline, wherein the saving the current context instruction state comprises storing the fetched instruction from the instruction queue to the corresponding instruction buffer of the current context.

17. The method of claim 16, wherein the restoring the context instruction state comprises restoring fetched instructions from the corresponding instruction buffer of the next context to the instruction queue.

18. The method of claim 17, wherein after the restoring the context instruction state to the pipeline, the method further comprises:
setting the selected next context as the current context; and
executing the restored fetched instructions by the instruction pipeline.

19. The method of claim 15, wherein the context switch event is determined in response to one of a cache miss, a response to an interrupt, or a message unavailable event.

20. The method of claim 15, wherein in response to the context switch event, the method further comprises flushing the pipeline.
